(19) United States
(12) Patent Application Publication
(10) Pub. No.: US 2010/0307616 A1
(43) Pub. Date: Dec. 9, 2010

(54) MICROFLUIDIC PUMP, FLUID GUIDING MODULE, AND FLUID TRANSPORTING SYSTEM

(75) Inventors: Dar-Sun Liou, Taoyuan County (TW); Long-Sheng Kuo, Taichung County (TW); Ping-Hei Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NATIONAL TAIWAN UNIVERSITY, Taipei (TW)

(21) Appl. No.: 12/507,077

(22) Filed: Jul. 22, 2009

(30) Foreign Application Priority Data
Jun. 5, 2009 (TW) 98118783

(51) Int. Cl. F15D 1/00; F04B 43/00

(52) U.S. Cl. 137/565.01; 417/480; 137/597; 137/561 R

(57) ABSTRACT

A fluid transporting system including a microfluidic pump, a fluid guiding unit, and a first pipe connected between the microfluidic pump and the fluid guiding unit is provided. The microfluidic pump includes a body, a first unidirectional membrane valve, and a second unidirectional membrane valve. The body has a cavity, an inlet connected to the first unidirectional membrane valve, and an outlet connected to the second unidirectional membrane valve. When the cavity is compressed, the first unidirectional membrane valve is closed, and the second one is opened. When the cavity is dilated, the first unidirectional membrane valve is opened, and the second one is closed. The fluid guiding unit includes a tank provided with a first channel, and a second channel. A height of the first channel relative to the bottom of the tank is higher than that of the second channel relative to the bottom of the tank.

### CROSS-REFERENCE TO RELATED APPLICATION

This application claims the priority benefit of Taiwan application serial no. 98118783, filed on Jun. 5, 2009. The entirety of the above-mentioned patent application is hereby incorporated by reference herein and made a part of specification.

### BACKGROUND OF THE INVENTION

1. Field of the Invention

The present invention relates to a fluid transporting system. More particularly, the present invention relates to a fluid transporting system comprising a microfluidic pump and a fluid guiding unit.

2. Description of Related Art

In a micro-electro-mechanical engineering domain, especially in a biomedical domain, driving and controlling motions of a micro fluid in fine network channels is a basic technique for developing microfluidic chips. Wherein, a microfluidic pump is an important device in the microfluidic chip that is used for controlling the motion of the fluid, which is also one of the focuses in research and development of lab on a chip.

In a current technique range, various pumps are applied to microfluidic chips. For example, an electro-osmotic pump that changes a bead surface tension according to a voltage difference, an injection pump that uses electric power to generate a mechanical motion, a centrifugal pump that generates fluid motions according to centrifugal caused by rotation, a micro voltage pump actuated by piezoelectric crystal and metal electrodes, and a heat pump in which a membrane vibration and channel control are implemented due to expansion of heated gas, etc.

However, the above commonly used pumps generally have following problems required to be resolved. For example, additional device have to be used to provide power for driving the pumps; the pump cannot be fabricated by a single material; a voltage drop problem has to be resolved; the pump has a complicated fabrication process and a cost of the pump is uneasy to be controlled, etc.

### SUMMARY OF THE INVENTION

The present invention is directed to a microfluidic pump having functions of transporting a fluid by a unidirectional approach, and preventing a backflow of the fluid.

The present invention is directed to a fluid guiding unit having a function of preventing a backflow of a fluid.

The present invention is directed to a fluid guiding module having functions of guiding and storing a fluid.

The present invention is directed to a fluid transporting system with a simple structure, a high durability, and a low fabrication cost.

The present invention provides a microfluidic pump, which is used for transporting a fluid. The microfluidic pump includes a body, a first unidirectional membrane valve, and a second unidirectional membrane valve. The body has a cavity, a fluid inlet, and a fluid outlet, wherein the cavity is connected between the fluid inlet and the fluid outlet. The first unidirectional membrane valve is disposed on the fluid inlet, and the second unidirectional membrane valve is disposed on the fluid outlet. When the cavity is compressed, the first unidirectional membrane valve is closed, and the second unidirectional membrane valve is opened, so that the fluid outflows the microfluidic pump through the second unidirectional membrane valve. When the cavity is dilated, the first unidirectional membrane valve is opened, and the second unidirectional membrane valve is closed, so that the fluid flows into the microfluidic pump through the first unidirectional membrane valve.

The present invention provides a fluid guiding unit for transporting a fluid. The fluid guiding unit includes a tank, at least a first channel, and at least a second channel. The tank has a storage cavity. The first and the second channels are respectively connected to the storage cavity, wherein a height of the first channel relative to the bottom of the tank is higher than a height of the second channel relative to the bottom of the tank.

The present invention provides a fluid guiding module including a plurality of fluid guiding units and at least one pipe. The at least one pipe is connected between any two of the fluid guiding units. Each of the fluid guiding units includes a tank, at least a first channel, and at least a second channel. The tank has a storage cavity. The first and the second channels are respectively connected to the storage cavity, wherein a height of the first channel relative to the bottom of the tank is higher than a height of the second channel relative to the bottom of the tank.

The present invention provides a fluid transporting system including at least one microfluidic pump, at least one fluid guiding unit, and at least one first pipe, wherein the first pipe is connected between the microfluidic pump and the fluid guiding unit. The microfluidic pump includes a body, a first unidirectional membrane valve, and a second unidirectional membrane valve. The body has a cavity, a fluid inlet, and a fluid outlet, wherein the cavity is connected between the fluid inlet and the fluid outlet. The first unidirectional membrane valve is disposed on the fluid inlet, and the second unidirectional membrane valve is disposed on the fluid outlet. When the cavity is compressed, the first unidirectional membrane valve is closed, and the second unidirectional membrane valve is opened, so that the fluid outflows the microfluidic pump through the second unidirectional membrane valve. When the cavity is dilated, the first unidirectional membrane valve is opened, and the second unidirectional membrane valve is closed, so that the fluid flows in the microfluidic pump through the first unidirectional membrane valve. The fluid guiding unit includes a tank, at least a first channel, and at least a second channel. The tank has a storage cavity. The first and the second channels are respectively connected to the storage cavity, wherein a height of the first channel relative to the bottom of the tank is higher than a height of the second channel relative to the bottom of the tank.

In an embodiment of the present invention, the first unidirectional membrane valve includes a first valve body and a first seal membrane. The first valve body has a first containing space. The first containing space is connected to the fluid inlet and has an opening. The opening is located opposite to and apart from the fluid inlet. The first seal membrane is located in the first containing space and is attached to the opening. When the cavity is compressed, the first seal membrane is closely attached to the opening. When the cavity is dilated, the fluid located outside the microfluidic pump partially pushes away the first seal membrane from the opening, so as to flow into the cavity.

In an embodiment of the present invention, the second unidirectional membrane valve includes a second valve body and a second seal membrane. The second valve body has a second containing space connected to the fluid outlet. The second seal membrane is located in the second containing space and is attached to the fluid outlet. When the cavity is dilated, the second seal membrane is closely attached to the fluid outlet. When the cavity is compressed, the fluid located inside the cavity partially pushes away the second seal membrane from the fluid outlet, so as to outflow the cavity.

In an embodiment of the present invention, the pipes are connected between the first channels of any two of the fluid guiding units.

In an embodiment of the present invention, the pipes are connected between the second channels of any two of the fluid guiding units.

In an embodiment of the present invention, the pipes are connected between the first channel and the second channel of any two of the fluid guiding units.

In an embodiment of the present invention, the pipes are tightly fitted to the first channel or the second channel.

In an embodiment of the present invention, the first pipe is connected between the fluid inlet and the first channel, and the first pipe is tightly fitted to the fluid inlet and the first channel, respectively.

In an embodiment of the present invention, the at least one fluid guiding unit includes a plurality of fluid guiding units mutually connected to each other, and the fluid transporting system further includes at least one second pipe connected between any two of the fluid guiding units.

In an embodiment of the present invention, the second pipe is tightly fitted to the first channel or the second channel of any two of the fluid guiding units.

In an embodiment of the present invention, the second pipe is connected between the first channel and the second channel of any two of the fluid guiding units.

In an embodiment of the present invention, the second pipe is connected between the first channels of any two of the fluid guiding units.

In an embodiment of the present invention, the second pipe is connected between the second channels of any two of the fluid guiding units.

According to the above descriptions, the microfluidic pump transports the fluid by compressing and dilating the cavity, and achieves a unidirectional fluid transporting by controlling the valves. Moreover, the fluid guiding unit in the fluid guiding module can achieve the unidirectional fluid transporting according to a height difference between the openings, and in coordination with the channels connected to the openings, the fluid guiding unit simultaneously has the functions of guiding and storing the fluid. Therefore, by combining the microfluidic pumps and the fluid guiding units to form the fluid transporting system, individual functions of the above units can be integrated, so that the fluid transporting system may have advantages of a simple structure, a high durability, and a low fabrication cost.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a microfluidic pump according to an embodiment of the present invention.

FIG. 2 and FIG. 3 are partial amplified diagrams respectively illustrating a first unidirectional membrane valve and a second unidirectional membrane valve in a microfluidic pump of FIG. 1.

FIG. 4 and FIG. 5 are diagrams respectively illustrating motion status of seal membranes during compression and dilation of a cavity.

FIG. 6 is a side view of a microfluidic pump of FIG. 1.

FIG. 7 is a schematic diagram illustrating a microfluidic pump according to another embodiment of the present invention.

FIG. 8 is a schematic diagram illustrating a fluid guiding module according to an embodiment of the present invention.

FIG. 9 and FIG. 10 are schematic diagrams respectively illustrating a fluid guiding module according to another embodiment of the present invention.

FIG. 11 is a schematic diagram illustrating a fluid transporting system according to an embodiment of the present invention.

FIG. 12 is a schematic diagram illustrating a fluid transporting system according to another embodiment of the present invention.

### DESCRIPTION OF THE EMBODIMENTS

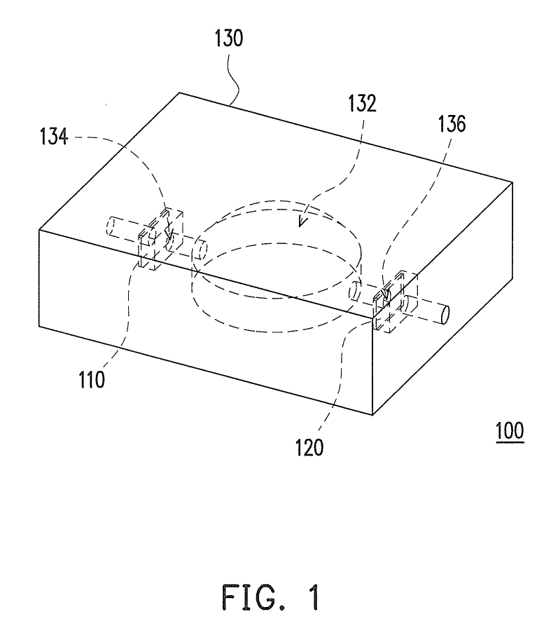

FIG. 1 is a schematic diagram illustrating a microfluidic pump according to an embodiment of the present invention. Referring to FIG. 1, the microfluidic pump 100 is used for transporting a fluid. The microfluidic pump 100 includes a body 130, a first unidirectional membrane valve 110, and a second unidirectional membrane valve 120. The body 130 has a cavity 132, a fluid inlet 134, and a fluid outlet 136, wherein the cavity 132 is connected between the fluid inlet 134 and the fluid outlet 136. The first unidirectional membrane valve 110 is disposed on the fluid inlet 134, and the second unidirectional membrane valve 120 is disposed on the fluid outlet 136. When the cavity 132 is compressed, the first unidirectional membrane valve 110 is closed, and the second unidirectional membrane valve 120 is opened, so that the fluid outflows the microfluidic pump 100 through the second unidirectional membrane valve 120. Conversely, when the cavity 132 is dilated, the first unidirectional membrane valve 110 is opened, and the second unidirectional membrane valve 120 is closed, so that the fluid flows into the microfluidic pump 100 through the first unidirectional membrane valve 110.

In the present embodiment, the microfluidic pump 100 has a simple structure. According to a mechanical compression, the cavity 132 can be compressed or dilated to change a pressure in the cavity 132, so as to open or close the first unidirectional membrane valve 110 and the second unidirectional membrane valve 120 for transporting the fluid. By such means, it is unnecessary to configure additional devices to the microfluidic pump 100 to provide power for transporting the fluid. Meanwhile, the fluid can only be transported by a unidirectional approach, so as to avoid a backflow of the fluid.

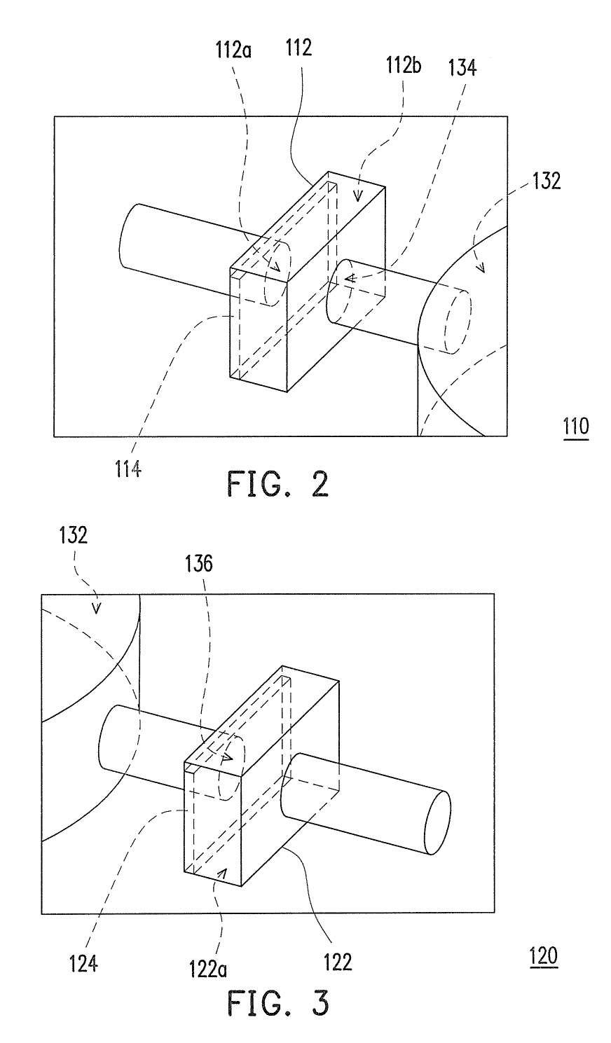

Further, FIG. 2 and FIG. 3 are partial amplified diagrams respectively illustrating the first unidirectional membrane valve and the second unidirectional membrane valve in the microfluidic pump of FIG. 1. Referring to FIG. 2 and FIG. 3, the body 130 is not illustrated, so as to clearly describe the first unidirectional membrane valve 110 and the second unidirectional membrane valve 120. The first unidirectional membrane valve 110 includes a first valve body 112 and a first seal membrane 114. The first valve body 112 has a first containing space 112b. The first containing space 112b is connected to the fluid inlet 134 and has an opening 112a. The opening 112a is located opposite to and apart from the fluid inlet 134. The first seal membrane 114 is located in the first containing space 112b and is attached to the opening 112a. The second unidirectional membrane valve 120 includes a second valve body 122 and a second seal membrane 124. The second valve body 122 has a second containing space 122a connected to the fluid outlet 136. The second seal membrane 124 is located in the second containing space 122a and is attached to the fluid outlet 136.

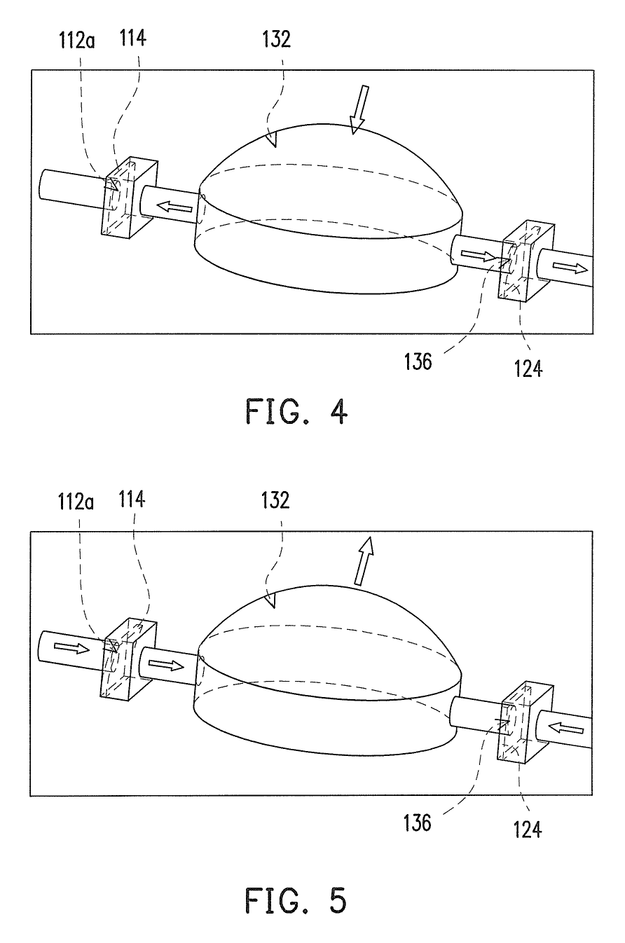

FIG. 4 and FIG. 5 are diagrams respectively illustrating motion status of the seal membranes during compression and dilation of the cavity. Here, the body 130 is also not illustrated, so as to clearly describe the components, wherein arrow symbols in the figures represent compressing and the dilating directions of the cavity 132, and flowing directions of the fluid. Referring to FIG. 4, when the cavity 132 is compressed, a volume of the cavity 132 is decreased, so that the pressure in the cavity 132 is increased. Now, a pressure of the fluid in the cavity 132 is greater than a pressure of the fluid outside the cavity 132, so that the first seal membrane 114 is closely attached to the opening 112a. Moreover, since an area of the first seal membrane 114 is greater than an aperture of the opening 112a, the first seal membrane 114 can totally seal the opening 112a to block the fluid from entering the cavity 132. On the other hand, the fluid in the cavity 132 can partially push away the second seal membrane 124 from the fluid outlet 136, so as to flow out from the microfluidic pump 100.

Referring to FIG. 5, when the cavity 132 is dilated, a volume of the cavity 132 is increased, so that the pressure in the cavity 132 is decreased. Now, a pressure of the fluid outside the cavity 132 is greater than a pressure of the fluid in the cavity 132, the fluid outside the cavity 132 can partially push away the first seal membrane 114 from the opening 112a, so as to flow into the cavity 132. The second seal membrane 124 located at another side of the cavity 132 is closely attached to the fluid outlet 136 to block the fluid from flowing back to the cavity 132 through the fluid outlet 136.

In the present embodiment, a material of the microfluidic pump 100 is polydimethylsiloxane (PDMS), which is a hydrophobic transparent elastomer that can absorb shocks and reduce impacts of stresses, so that the cavity 132 of the microfluidic pump 100 can be compressed and dilated.

Since the volume of the cavity 132 is fixed, when the cavity 132 is compressed or dilated, an original state of the cavity 132 can be restored according to the high flexibility of the PDMS material. Accordingly, a volume variation of the cavity 132 is also fixed, so that the fluid flowing into or out from the microfluidic pump 100 can maintain a fixed flux. By such means, a user can control a flux of the fluid in the microfluidic pump 100 by designing the volume of the cavity 132.

Moreover, the PDMS material has an excellent electrical insulation property, and has a good dielectric strength and water proof capability, and the material itself can also resist the ozone and the ultraviolet (UV) light, which is regarded as an inert substance in a biochemical domain, so that such material is suitable to serve as a biomedical material.

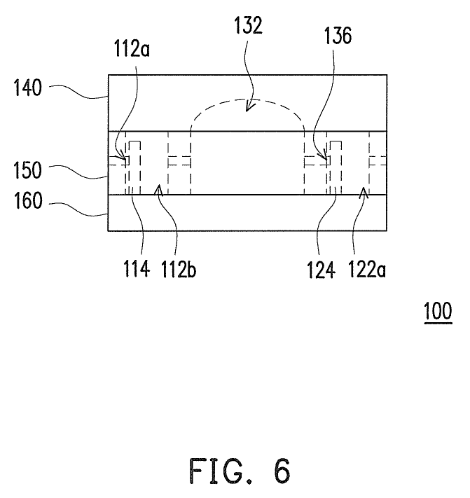

FIG. 6 is a side view of the microfluidic pump of FIG. 1. The structure of the microfluidic pump 100 is described according to FIG. 6. The microfluidic pump 100 of the present embodiment includes a first element 140, a second element 150 and a third element 160, wherein the first element 140 and the second element 150 commonly form the cavity 132 of the microfluidic pump 100, and the second element 150 simultaneously forms the first unidirectional membrane valve 110 and the second unidirectional membrane valve 120.

During a fabrication process of the microfluidic pump 100, the three elements 140, 150 and 160 are first fabricated according to a molding process, wherein the first element 140 and the second element 150 are respectively fabricated into a part of the cavity 132, and the second element 150 also forms the first containing space 112b and the second containing space 122a. Next, the first seal membrane 114 and the second seal membrane 124 are respectively attached to the opening 112a and the fluid outlet 136. Then, the PDMS solution is coated among the elements 140, 150 and 160 for adhesion, so as to assemble the three elements 140, 150 and 160 into the microfluidic pump 100. Therefore, the elements 140, 150 and 160 and the adhesive of the assembled microfluidic pump 100 are all fabricated by PDMS. Accordingly, there is no seam among the elements 140, 150 and 160 of the microfluidic pump 100, and the microfluidic pump 100 may have an integral profile, so that fluid leakage among the elements 140, 150 and 160 is avoided. On the other hand, since the microfluidic pump 100 has a simple structure and can be mass-produced according to the molding process, a fabrication cost thereof is greatly reduced.

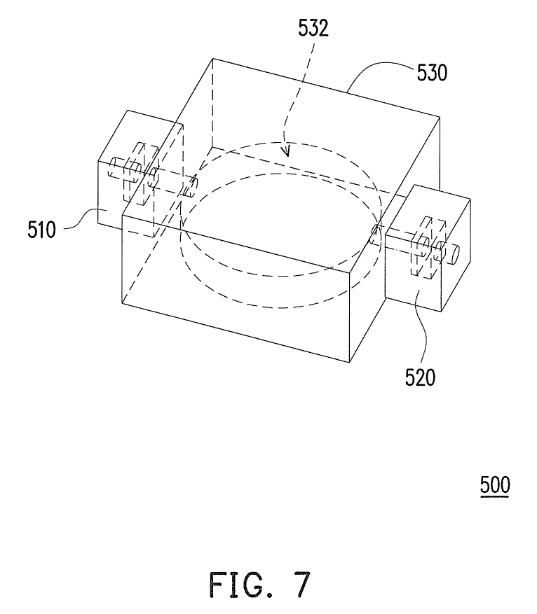

The fabrication process of the microfluidic pump 100 is not limited by the present invention. FIG. 7 is a schematic diagram illustrating a microfluidic pump according to another embodiment of the present invention. Referring to FIG. 7, in the present embodiment, during a fabrication process of the microfluidic pump 500, a body 530 and a cavity 532 therein can be first fabricated, and then a first unidirectional membrane valve 510 and a second unidirectional membrane valve 520 are respectively fabricated. Finally, the body 530, the first unidirectional membrane valve 510 and the second unidirectional membrane valve 520 are adhered by the PDMS solution to form the microfluidic pump 500.

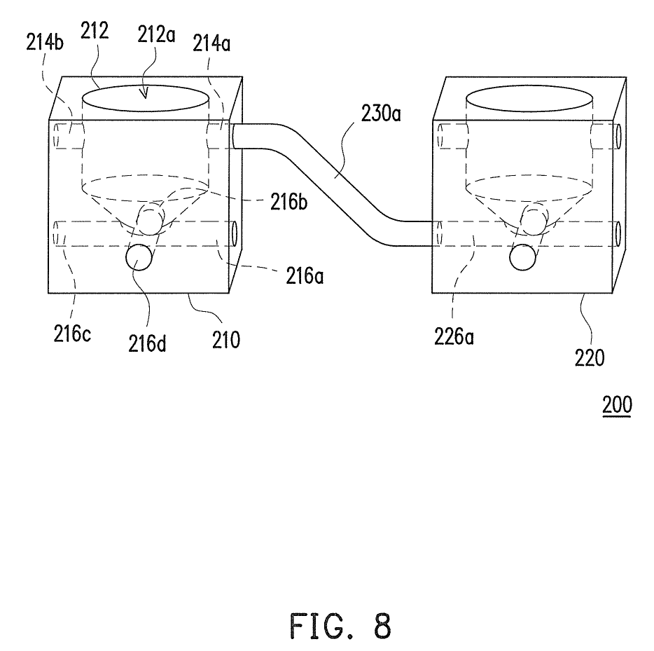

FIG. 8 is a schematic diagram illustrating a fluid guiding module according to an embodiment of the present invention. Referring to FIG. 8, two mutually connected fluid guiding units are used for description. The fluid guiding module 200 includes two mutually connected fluid guiding units 210 and 220, and a pipe 230a. In the present embodiment, the fluid guiding unit 210 includes a tank 212, first channels 214a and 214b, and second channels 216a, 216b, 216c and 216d. The tank 212 has a storage cavity 212a. The first channels 214a and 214b are respectively connected to the storage cavity 212a, wherein a height of the first channels 214a and 214b relative to a bottom of the tank 212 is greater than a height of the second channels 216a, 216b, 216c and 216d relative to the bottom of the tank 212, so that after the fluid flows into the tank 212, the fluid can only outflow from the second channels 216a, 216b, 216c and 216d. Therefore, the fluid guiding unit 210 has a function of preventing a backflow of the fluid. Moreover, the structure of the fluid guiding unit 220 is similar to that of the fluid guiding unit 210, and therefore detail description thereof is not repeated.

In addition, an outer diameter of the pipe 230a is greater than an inner diameter of the channels of the fluid guiding units 210 and 220. Therefore, the pipe 230a can be tightly fitted to the fluid guiding units 210 and 220 according to the properties of the PDMS material, so as to avoid leakage of the fluid.

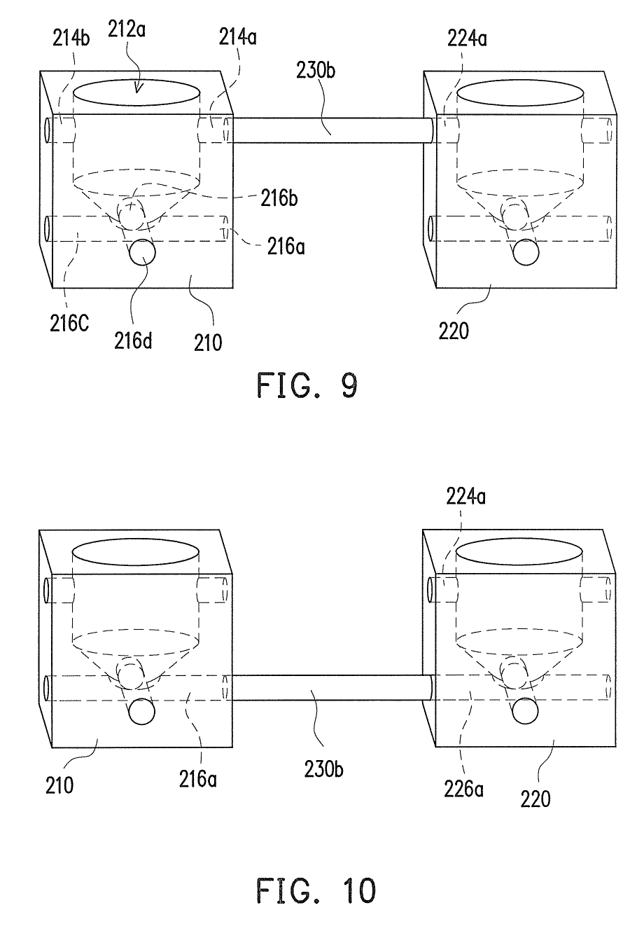

In the preset embodiment, the first channel 214a of the fluid guiding unit 210 and the second channel 226a of the fluid guiding unit 220 are mutually connected, though the connecting method between the fluid guiding units 210 and 220 is not limited thereto. FIG. 9 and FIG. 10 are schematic diagrams respectively illustrating a fluid guiding module according to another embodiment of the present invention. Referring to FIG. 9 and FIG. 10, in the embodiment of FIG. 9, the first channel 214a of the fluid guiding unit 210 and the first channel 224a of the fluid guiding unit 220 are mutually connected through the pipe 230b. In the embodiment of FIG. 10, the second channel 216a of the fluid guiding unit 210 and the second channel 226a of the fluid guiding unit 220 are mutually connected through the pipe 230b.

In the embodiments of FIGS. 8-10, the connecting method of the fluid guiding units 210 and 220, and a quantity thereof is not limited by the present invention, which can be modified by the user according to a using condition and environment of the fluid.

It should be noticed that in the embodiments of FIG. 8 and FIG. 9, once the second channels 216a, 216b, 216c and 216d of the fluid guiding unit 210 are closed, when the fluid flows into the storage cavity 212a through the first channel 214a or 214b, it can be stored in the storage cavity 212a. By such means, the user can detect the fluid in the storage cavity 212a, and then open the second channels 216a, 216b, 216c and 216d to transport the detected fluid to the other places.

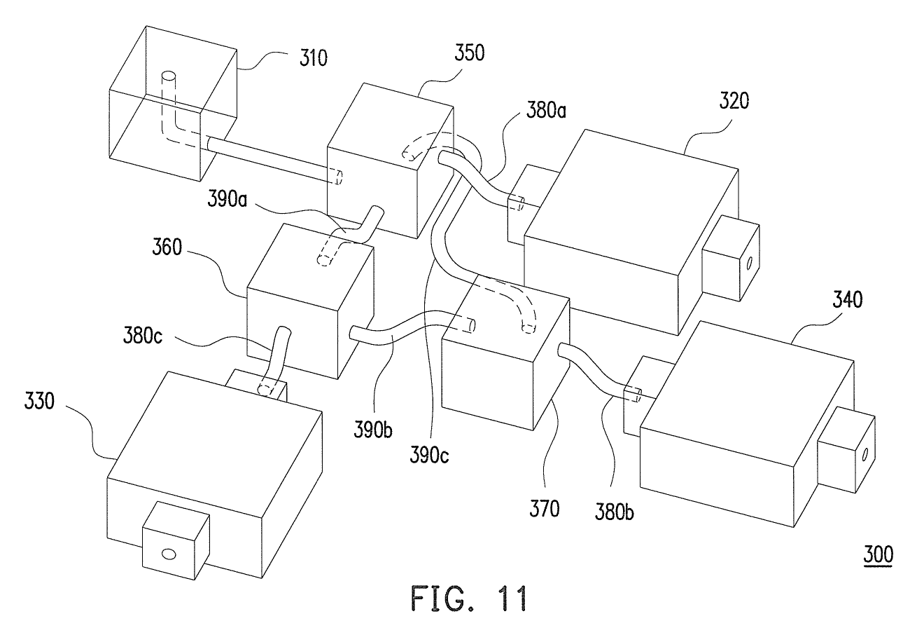

FIG. 11 is a schematic diagram illustrating a fluid transporting system according to an embodiment of the present invention. Referring to FIG. 11, the fluid transporting system 300 includes a fluid injecting tank 310, microfluidic pumps 320, 330 and 340, fluid guiding units 350, 360 and 370, first pipes 380a, 380b and 380c, and second pipes 390a, 390b and 390c. In the present embodiment, the microfluidic pumps 320, 330, 340 and the fluid guiding units 350, 360, 370 have all been described in the aforementioned embodiment, and therefore detail descriptions thereof are not repeated.

In the present embodiment, by compressing the microfluidic pump 320, the fluid (for example, air) in the fluid guiding unit 350 flows into the microfluidic pump 320 through the first pipe 380a, so that the fluid guiding unit 350 is in a low pressure state. Accordingly, the fluid (for example, a detection reagent) in the fluid injecting tank 310 can be attracted to the fluid guiding unit 350 due to a pressure difference. Thereafter, by pressing the microfluidic pump 340, the air in the fluid guiding unit 360 is transported to the microfluidic pump 330 through the first pipe 380c, so that the fluid guiding unit 360 is in the low pressure state. Therefore, the detection reagent in the fluid guiding unit 350 is transported to the fluid guiding unit 360 through the second pipe 390a. Similarly, by pressing the microfluidic pump 340, the detection reagent in the fluid guiding unit 360 can be transported to the fluid guiding unit 370, and the detection reagent transported to the fluid guiding unit 370 is again transported to the fluid guiding unit 350 due to an influence of the microfluidic pump 320.

Accordingly, by using the microfluidic pumps 320, 330, 340 and the fluid guiding units 350, 360, 370, the fluid can be continuously cycled in the fluid transporting system 300. When the fluid transporting system 300 is applied to a biomedical detection apparatus, the user can respectively detect the fluid in the fluid guiding units 350, 360, 370 or in the second pipes 390a, 390b, 390c, or can configure other devices between the second pipes 390a, 390b and 390c to process or detect the fluid therein.

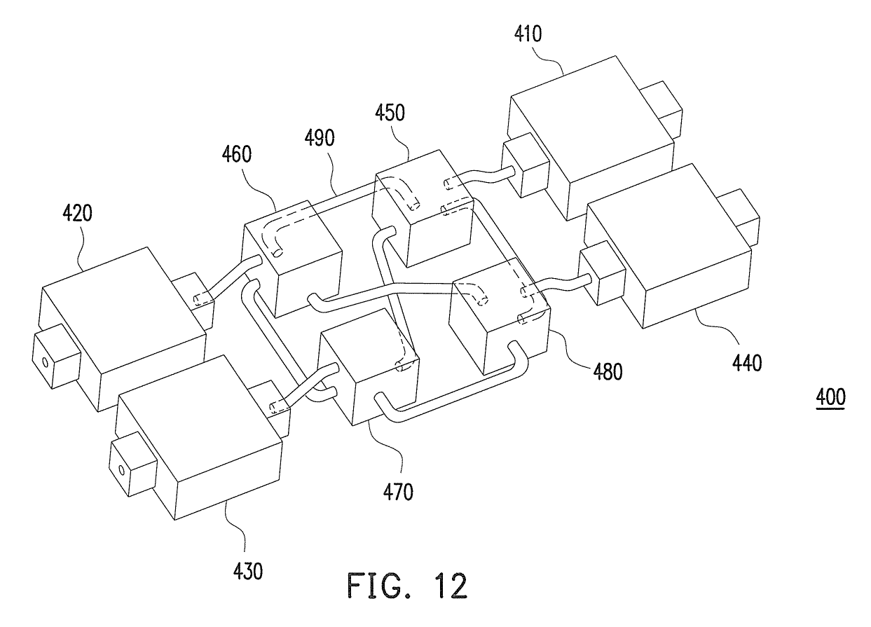

FIG. 12 is a schematic diagram illustrating a fluid transporting system according to another embodiment of the present invention. Referring to FIG. 12, in the present embodiment, the fluid transporting system 400 includes four microfluidic pumps 410, 420, 430, 440, and four fluid guiding units 450, 460, 470 and 480, wherein the second pipe 490 is connected between any two of the fluid guiding units, and quantities of the microfluidic pumps and the fluid guiding units are not limited by the present invention.

The driving method among the microfluidic pumps 410, 420, 430, 440 and the fluid guiding units 450, 460, 470, 480 is as that described in the aforementioned embodiment, so that a detail description thereof is not repeated. A difference between the present embodiment and the aforementioned embodiment is that the user can drive different microfluidic pumps 410, 420, 430 and 440 to transport the fluid to the predetermined fluid guiding units 450, 460, 470 and 480. In other words, since the fluid guiding units 450, 460, 470 and 480 are mutually connected to form a two-dimensional fluid system, the fluid can be continuously transported among the fluid guiding units 450, 460, 470 and 480 according to predetermined paths by compressing the microfluidic pumps 410, 420, 430 and 440.

In addition, besides transporting the fluid, the microfluidic pumps 410, 420, 430 and 440 of the fluid transporting system 400 further have a channel switching function, so as to control a flowing direction of the fluid among the fluid guiding units 450, 460, 470 and 480.

Moreover, a control system (not shown) can also be applied to set a driving time and frequency of each of the microfluidic pumps 410, 420, 430 and 440, so that the fluid in the fluid guiding units 450, 460, 470 and 480 can be transported according to the setting time and frequency.

In summary, in the embodiments of the present invention, by compressing or dilating the cavity to open or close the fluid inlet/outlet, the microfluidic pump can transport the fluid by the unidirectional approach and prevent backflow of the fluid. Moreover, since the whole microfluidic pump is formed by the PDMS material, the cavity may have a good flexibility due to the material, so that the volume variation of the cavity is fixed, and accordingly the flux of the fluid is fixed. In addition, there is no seam among the elements of the microfluidic pump, so that fluid leakage can be avoided.

On the other hand, the heights of the channels of the fluid guiding unit are different, so that the fluid flowed in the fluid guiding unit can only flow out from the channel located at the lower part of the tank. Therefore, the fluid guiding unit can not only transport the fluid by the unidirectional approach, once the channel at the lower part of the tank is closed, the fluid guiding unit can also be used for storing the fluid.

Moreover, the fluid transporting system including the microfluidic pumps and the fluid guiding units not only has the individual functions of the microfluidic pumps and the fluid guiding units, but can also integrate the functions to achieve functions of flow splitting, flow converging, and fluid circulation, so that the user can set different driving conditions for the microfluidic pumps to achieve diversified functions of the fluid transporting system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A microfluidic pump, used for transporting a fluid, the microfluidic pump comprising:
a body, having a cavity, a fluid inlet, and a fluid outlet, wherein the cavity is connected between the fluid inlet and the fluid outlet;
a first unidirectional membrane valve, disposed on the fluid inlet; and
a second unidirectional membrane valve, disposed on the fluid outlet, wherein when the cavity is compressed, the first unidirectional membrane valve is closed, and the second unidirectional membrane valve is opened, so that the fluid outflows the microfluidic pump through the second unidirectional membrane valve, and when the cavity is dilated, the first unidirectional membrane valve is opened, and the second unidirectional membrane valve is closed, so that the fluid flows into the microfluidic pump through the first unidirectional membrane valve.

2. The microfluidic pump as claimed in claim 1, wherein the first unidirectional membrane valve comprises:
a first valve body, having a first containing space connected to the fluid inlet, the first containing space having an opening located opposite to and apart from the fluid inlet; and
a first seal membrane, located in the first containing space and attached to the opening, wherein when the cavity is compressed, the first seal membrane is closely attached to the opening, and when the cavity is dilated, the fluid located outside the cavity partially pushes away the first seal membrane from the opening, so as to flow into the cavity.

3. The microfluidic pump as claimed in claim 1, wherein the second unidirectional membrane valve comprises:
a second valve body, having a second containing space connected to the fluid outlet; and
a second seal membrane, located in the second containing space and attached to the fluid outlet, wherein when the cavity is dilated, the second seal membrane is closely attached to the fluid outlet, and when the cavity is compressed, the fluid located inside the microfluidic pump partially pushes away the second seal membrane from the fluid outlet, so as to outflow the cavity.

4. A fluid guiding module, comprising:
a plurality of fluid guiding units connected to each other, and each of the fluid guiding units comprising:
a tank, having a storage cavity;
at least a first channel, connected to the storage cavity;
at least a second channel, connected to the storage cavity, wherein a height of the first channel relative to a bottom of the tank is higher than a height of the second channel relative to the bottom of the tank; and
at least one pipe, connected between any two of the fluid guiding units.

5. The fluid guiding module as claimed in claim 4, wherein the at least one pipe is connected between the first channels of any two of the fluid guiding units.

6. The fluid guiding module as claimed in claim 4, wherein the at least one pipe is connected between the second channels of any two of the fluid guiding units.

7. The fluid guiding module as claimed in claim 4, wherein the at least one pipe is connected between the first channel and the second channel of any two of the fluid guiding units.

8. The fluid guiding module as claimed in claim 4, wherein the at least one pipe is tightly fitted to the first channel or the second channel.

9. A fluid transporting system, comprising:
at least one microfluidic pump, comprising:
a body, having a cavity, a fluid inlet, and a fluid outlet, wherein the cavity is connected between the fluid inlet and the fluid outlet;
a first unidirectional membrane valve, disposed on the fluid inlet; and
a second unidirectional membrane valve, disposed on the fluid outlet, wherein when the cavity is compressed, the first unidirectional membrane valve is closed, and the second unidirectional membrane valve is opened, so that the fluid outflows the microfluidic pump through the second unidirectional membrane valve, and when the cavity is dilated, the first unidirectional membrane valve is opened, and the second unidirectional membrane valve is closed, so that the fluid flows in the microfluidic pump through the first unidirectional membrane valve; and
at least one fluid guiding unit, comprising:
a tank, having a storage cavity;
at least one first channel, connected to the storage cavity; and
at least one second channel, connected to the storage cavity, wherein a height of the first channel relative to the bottom of the tank is higher than a height of the second channel relative to the bottom of the tank; and
at least one first pipe, connected between the microfluidic pump and the fluid guiding unit.

10. The fluid transporting system as claimed in claim 9, wherein the first pipe is connected between the fluid inlet and the first channel.

11. The fluid transporting system as claimed in claim 10, wherein the first pipe is tightly fitted to the fluid inlet and the first channel, respectively.

12. The fluid transporting system as claimed in claim 9, wherein the at least one fluid guiding unit comprises a plurality of fluid guiding units mutually connected to each other, and the fluid transporting system further comprises at least one second pipe connected between any two of the fluid guiding units.

13. The fluid transporting system as claimed in claim 12, wherein the second pipe is tightly fitted to the first channel or the second channel of any two of the fluid guiding units.

14. The fluid transporting system as claimed in claim 12, wherein the second pipe is connected between the first channel and the second channel of any two of the fluid guiding units.

15. The fluid transporting system as claimed in claim 12, wherein the second pipe is connected between the first channels of any two of the fluid guiding units.

16. The fluid transporting system as claimed in claim 12, wherein the second pipe is connected between the second channels of any two of the fluid guiding units.

17. The fluid transporting system as claimed in claim 9, wherein the first unidirectional membrane valve comprises:
a first valve body, having a first containing space connected to the fluid inlet, the first containing space having an opening located opposite to and apart from the fluid inlet; and
a first seal membrane, located in the first containing space and attached to the opening, wherein when the cavity is compressed, the first seal membrane is closely attached to the opening, and when the cavity is dilated, the fluid located outside the cavity partially pushes away the first seal membrane from the opening, so as to flow into the cavity.

18. The fluid transporting system as claimed in claim 9, wherein the second unidirectional membrane valve comprises:
a second valve body, having a second containing space connected to the fluid outlet; and
a second seal membrane, located in the second containing space and attached to the fluid outlet, wherein when the cavity is dilated, the second seal membrane is closely attached to the fluid outlet, and when the cavity is compressed, the fluid located inside the cavity partially pushes away the second seal membrane from the fluid outlet, so as to outflow the cavity.

19. A fluid guiding unit, used for transporting a fluid, the fluid guiding unit comprising:
a tank, having a storage cavity;
at least a first channel, connected to the storage cavity; and
at least a second channel, connected to the storage cavity, wherein a height of the first channel relative to the bottom of the tank is higher than a height of the second channel relative to the bottom of the tank.
